(19) United States
(12) Patent Application Publication
(10) Pub. No.: US 2025/0097999 A1
(43) Pub. Date: Mar. 20, 2025

(54) HOUSEHOLD APPLIANCE, SYSTEM HAVING THE HOUSEHOLD APPLIANCE, AND METHOD OF CONTROLLING THE HOUSEHOLD APPLIANCE

(71) Applicant: BSH Hausgeräte GmbH, München (DE)

(72) Inventors: Bettina EISCH, Tegernheim (DE); Eduardo VELEZ PELLICER, Zaragoza (ES); Francisco IRACHE RASAL, Zaragoza (ES); Daniel SCHINDLER, Bad Abbach (DE); Bilel SEEL, Ergoldsbach (DE)

(21) Appl. No.: 18/802,616

(22) Filed: Aug. 13, 2024

(30) Foreign Application Priority Data
Sep. 18, 2023 (EP) 23382943

(51) Int. Cl. H04W 76/10

(52) U.S. Cl. CPC H04W 76/10

(57) ABSTRACT

A household appliance contains a control unit for controlling a function of the household appliance dependent on a user setting and a wireless interface for communicating with a mobile device. The control unit is adapted to establish a wireless connection between the household appliance and the mobile device and to exchange user setting data with the mobile device.

### CROSS-REFERENCE TO RELATED APPLICATION

This application claims the priority, under 35 U.S.C. § 119, of European Patent Application EP 23382943, filed Sep. 18, 2023; the prior application is herewith incorporated by reference in its entirety.

### FIELD AND BACKGROUND OF THE INVENTION

Present invention concerns controlling a household appliance. More specifically, the present invention concerns controlling a household appliance based on the preferences of a user.

A coffee maker may be used for producing a broad range of different variations of coffee specialties. A user may select his favorite coffee recipe and the coffee maker will control the process of coffee making to the likings of the user. In a modern coffee maker, many parameters may be controllable by the user. The user may spend some time configuring the coffee maker to make it produce coffee to his or her liking. The person may find herself in a different place with a coffee maker of the same type but without the custom user configuration. It may be hard for the person to reproduce her favorite settings by going through a preferences menu of the coffee maker. The same problem may occur at a different household appliance like a programmable cooker or a microwave oven.

### SUMMARY OF THE INVENTION

An object of the present invention therefore lies in providing an improved technique for controlling a household appliance in accordance to a user setting. The invention solves the given object through subject matter of enclosed independent claims. Subclaims give advantageous embodiments.

According to a first aspect of the present invention, a household appliance contains a control unit for controlling a function of the household appliance dependent on a user setting; and a wireless interface for communicating with a mobile device. The control unit is adapted to exchange user setting data with the mobile device.

Through the possibility of exchanging user setting data with the mobile device, a user may be enabled to carry settings from one household appliance to another one. The user setting data may consume very little space on the mobile device and the user may have the mobile device with him most of the time. Therefore, the user may control a household appliance according to his preferred user settings wherever he or she may go.

It is preferred that the wireless interface comprises an NFC interface. NFC stands for Near Field Communication and operates usually over a distance of four centimeters or less. Through the limited range for communication, there is inherent security against malicious use of the household appliance. NFC interfaces have become common on mobile devices such as smartphones, smartwatches or smart bands.

Communication between the household appliance and the mobile device may be done through a standard called NDEF (NFC Data Exchange Format) which is especially suited for text-based data such as a user setting data for the household appliance. Also, NDEF may offer a high level of transfer security through error checking and error correction. One more advantage of NDEF is that it defines a standardized format for common data types. One format concerns text which may be used for controlling the appliance.

The wireless connection may also be realized differently, e.g. via WiFi or Bluetooth, especially for exchange of credentials or access tokens, and the other connection may also have defined data types that are suitable for the purposes described herein. Thus, a high degree of interoperability with smartphone OS out of the box for appliance commissioning in home network or communication handover may be reached.

The NFC interface may be capable of passive operation only. In passive mode, electric energy for processing or communication is harvested from an alternating electric field which is controlled by an active NFC interface. As mobile devices usually feature active NFC interfaces, it may suffice for interoperation to use a passive-only NFC interface on the side of the appliance. This may help keep production cost for the household appliance low.

According to another embodiment of present invention, the wireless interface is a first wireless interface and there is also provided a second wireless interface. In this, the control unit is adapted to establish a data link on the second wireless interface through communication on the first wireless interface.

The second wireless interface may for instance comprise Bluetooth (BT), Bluetooth Low Energy (BLE) or Wi-Fi/WLAN. Security features of the first wireless interface may be used for exchanging a token or authentication data. Communication on the second interface may be controlled through this security information. The second interface may be adapted to provide higher data rates, a higher transport security, a longer range or support the transfer of larger data chunks. The household appliance may already comprise a second wireless interface for communicating with a local or external server or service. User setting data may also be exchanged or synchronized with such a service. The mobile device, too, may feature a compatible second wireless interface. The external service may also be used for authentication purposes.

It is preferred that the control unit is adapted to transfer user setting data to the mobile device. Before or after a data link over the wireless interface has been established, a user may be prompted to select the user setting data that is to be transferred. On the mobile device, received user setting data may be stored under a name which the user may provide.

The control unit may be adapted to accept user setting data from the mobile device and to control the function dependent on the accepted user setting data. For this process, the user may be asked to identify the user setting data he or she wishes to transfer to the household appliance.

It is preferred that the household appliance treats received user setting data as temporary data only. After the function has been carried out successfully, the accepted user setting data may be deleted. However, it is also possible to store the transferred data in a local data store for later use. This makes it possible for users to exchange user setting data with each other.

In one especially preferred embodiment, the wireless interface comprises a loop antenna that is realized through conductive strips on a transparent film; the film being disposed at or near an outer surface of the appliance. The loop antenna may be flat and pressed against an outer surface of the household appliance. It may thus be hardly visible for a user. The transparent film may help cover sensitive structures of the loop antenna. Through its disposition on the outside of the household appliance, a maximum communication distance to a mobile device may be easily complied with.

The transparent film may also comprise conductive patches wherein the control unit is adapted to determine a touch of the film at a conductive patch based on a change in capacitance of that patch. The touch may especially come from a finger or another bodily part of a user. The film may thus also act as an input device to the household appliance. Operation of the household appliance and especially compiling user setting data may be done through this input device. The transparent film with the conductive structures may be disposed in front of or behind a display unit. The display unit, together with the conductive patches, may form a touch screen. Loops of the antenna may extend around a visible area of the display. It is especially preferred that the control unit is mounted on the back of transparent film or of the display. The control unit may form one integrated unit together with the input device and the output device. This unit may be highly integrated and can be manufactured cost-effectively. The unit may consume only little space and can be adapted to use at a wide variety of different household devices.

According to yet another preferred embodiment, the control unit is adapted to provide identification information of the household appliance through the wireless interface. The control unit may act as a wireless tag and information that is required, say, for servicing, may be provided in an electronic form. This may help maintaining and using the household appliance through its product life.

The wireless interface may comprise a flat antenna, especially a loop antenna, wherein a patch with printed identification information of the household appliance covers the antenna. A user may see only the patch with the printed information but the same information or related information may also be read out electronically through the wireless interface that is attached to the patch.

It is especially preferred that the household appliance contains a kitchen machine like a hob, a cooker hood, an oven or a steam cooker. In such machines special care must be taken that sticky or aggressive substances are kept outside the household appliance and do not interfere with a user interface. Present invention may help designing a user interface such that this object can be met.

According to yet another aspect of present invention, a system contains a first household appliance and a second household appliance. The first household appliance as described herein is adapted to transfer user setting data to a mobile device. The second household appliance as described herein is adapted to accept user setting data from a mobile device and control a function dependent on the accepted user setting data.

The system may also comprise a mobile device. The mobile device may especially comprise a smartphone. The smartphone may have an application running that permits a user to organize and/or edit user setting data that is stored on the smartphone. In one further embodiment, a manual for configuring user setting data to control a given household appliance may be provided on the smartphone.

A first method for controlling a first household appliance includes the steps of establishing a wireless connection between the first household appliance and a mobile device; determining user setting data which controls a function of the household appliance; and transferring the user setting data to the mobile device.

A second method for controlling a second household appliance includes the steps of establishing a wireless connection between the second household appliance and a mobile device; accepting user setting data from the mobile device; and controlling a function of the household appliance dependent on the accepted user setting data.

A method may be carried out with one or two household appliances as described herein. The method may be realized as a computer program product with program code means and may be stored on a computer readable media. The method may be adapted to be carried out, completely or in part, by a processing means. The processing means may be of electronic nature comprise a micro computer or micro controller, an ASIC or a similar device. Features or advantages of the method may be applicable to a corresponding device or system as well as vice versa.

Other features which are considered as characteristic for the invention are set forth in the appended claims.

Although the invention is illustrated and described herein as embodied in controlling a household appliance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is an illustration showing a system with two exemplary household appliances;

FIG. 2 is a flow diagram of two interconnected methods;

FIG. 3 is an illustration of exemplary user interfaces for a household appliance;

FIG. 4 is an illustration showing an exemplary control unit for a household appliance; and

FIG. 5 is an illustration showing an identification patch for covering a flat antenna of a control unit of a household appliance.

### DETAILED DESCRIPTION OF THE INVENTION

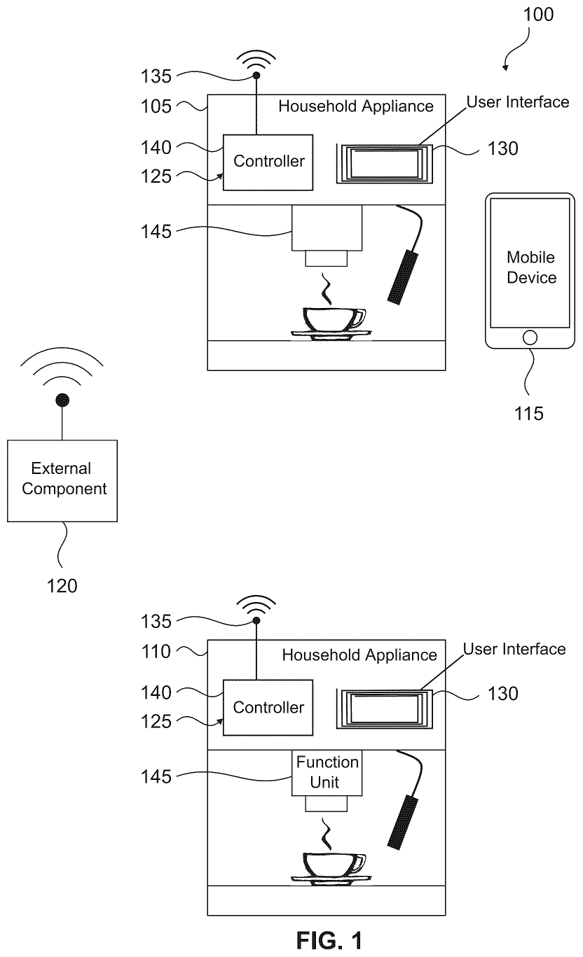

Referring now to the figures of the drawings in detail and first, particularly to FIG. 1 thereof, there is shown a system 100 with two exemplary household appliances. A first household appliance 105 is displayed on top, a second household appliance 110 near the bottom of the drawing. The system 100 may comprise a mobile device 115 and there may also be an external component 120.

The household appliances 105, 110 may be of the same type and configured similarly. A household appliance 105, 110 comprises a control unit 125 and a first wireless interface 130. Optionally, there may be a second wireless interface 135. An input/output unit 140 may provide a way for a user to interact with the control unit 125. The control unit 125 is adapted to control a function of the first or second household appliance 105, 110. The household appliance 105, 110 may comprise a functional unit 145, which may be controlled by the control unit 125 in the process. In the presently shown, exemplary embodiment, the household appliances 105, 110 comprise integrated coffee makers and the functional unit 145 may comprise a brewing group, a coffee mill or a milk frother.

The mobile device 115 is usually associated to a predetermined person. The mobile device 115 may comprise a smartphone, a laptop computer, a tablet computer or a wearable computer, such as a smartwatch or a smart band. The mobile device 115 is adapted to communicate with a household appliance 105, 110 via the first or second wireless interface 130, 135. The mobile device 115 may also have a storage unit and a user interface. A processing unit of the mobile device 115 may execute an application that helps communicating with one of the household appliances 105, 110, transferring user setting data, organizing, editing and/or storing that data.

The first wireless interface 130 of household appliances 105, 110 is preferred for direct operation over a short communication distance. It is especially preferred, that the first wireless interface 130 comprises an NFC interface. The optional second wireless interface 135 may support a different communication technique which stretches over a larger distance and which may support a higher band with. The second wireless interface 135 may especially cover Bluetooth, Bluetooth Low Energy or Wi-Fi.

In one embodiment, communication between the mobile device 115 and a household device 105, 110 is realized over the first wireless interface 130. In another embodiment, communication over the first wireless interface 130 is used for establishing any communication over the second wireless interface 135. A household device 105, 110 may communicate over the second wireless interface 135 with the external component 120.

The external component 120 may be disposed in the same household as one of the household appliances 105, 110 or in a different place. In one embodiment, the external component 120 is embodied as a remote server or service which can be accessed over a wide area network such as the internet or a mobile telephone system. The external component 120 may be adapted to store information related to a household device 105, 110 or a user that is associated with it. Generally, information that pertains to a user or a household appliance 105, 110 not be shared with a user or appliance 105, 110 of a different household. However, the component 120 may play a role in authentication and for instance an authentication token or a hash may be shared between the first and second household appliances 105, 110 and possibly be relayed over the external component 120.

A household appliance 105, 110 may be configured by a user to perform a function in a certain way. Configuration data for controlling the function to the users liking is called user setting data herein. It is proposed that user setting data relating to a function of the first household appliance 105 may be transferred wirelessly to the mobile device 115. The mobile device 115 may then be brought to the second household appliance 110, which is usually disposed in a different household. User setting data may then be transferred from the mobile device 115 to the second household appliance 110 and a function of the second household appliance 110 may be carried out dependent on the received user setting data.

The household appliances 105, 110 are preferred to be of the same type and equipment. Should the household appliances 105, 110 be differently equipped, functionalities may be mapped to that user setting data which tries to access a non-existent component that can be adapted to function as well.

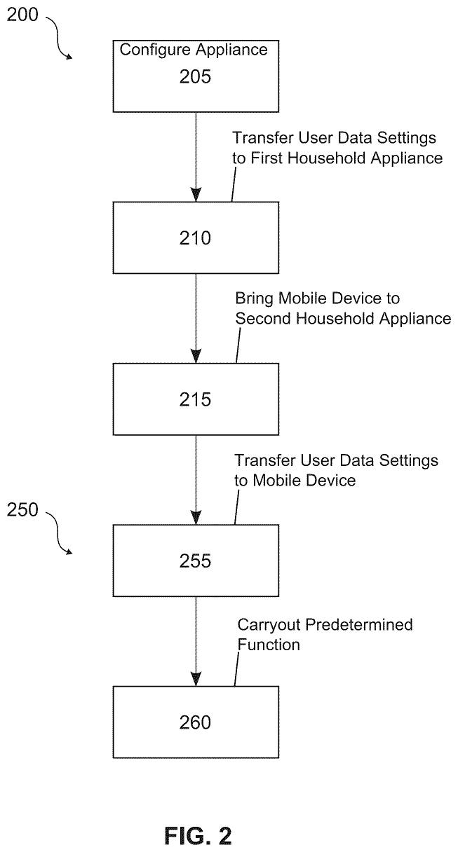

FIG. 2 shows a flow diagram of two interconnected methods. A method 200 which may also be referred to as a first method 200, starts in a step 205, in which the first household appliance 105 is configured by a user for carrying out a predetermined function in a way the user approves of. Note that this process may comprise elaborate and prolong changing of parameters.

In a successive step 210, user setting data that defines the way the function is executed may be transferred to the mobile device 115. For this, the mobile device 115 may be brought in close proximity to the first household appliance 105 and data may be transferred over the first wireless interface 130. After uploading that user configuration data to the mobile device 115, the mobile device 115 may be brought to the second household appliance 110 in a step 215.

A following part of method 200 may be considered a continuation of method 200 or as a separate second method 250. In a step 255, user setting data may be transferred from the mobile device 115 to the second household appliance 110. For this, the mobile device 115 may be brought in close proximity to the second household appliance 110 and data transfer may be conducted through the first wireless interface 130. In step 260 a predetermined function of the second household appliance 110 may be carried out, controlled by the downloaded user setting data. After the function has been carried out, the previously received user configuration data may be discarded. Optionally there may be support for storing the downloaded user setting data in a local data store of the second household appliance 110.

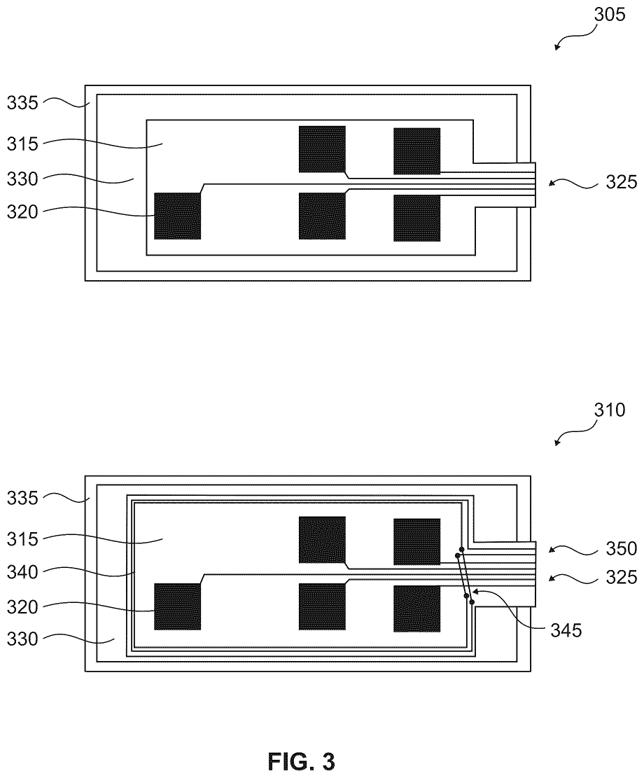

FIG. 3 shows exemplary user interfaces for a household appliance 105, 110. In an upper section, a known first user interface 305 is shown, whereas in a lower section a novel second user interface 310 can be seen. A user interface 305, 310 may form part of a control unit 125. The first user interface 305 comprises a film 315, which is preferred to be transparent. On the film 315 conductive structures are disposed. Conductive patches 320 form electrodes for measuring capacitance. Wires 325 connect the patches 320 to an evaluation circuit.

The film 315 may be disposed above or below a display unit 330, which may be disposed on a printed circuit board 335. The display unit 330 may feature an active or passive display which may be based, for instance, on LED, LCD or E-Ink technology. The second user interface 310 proposes a slight modification to the conductive structures on the transparent film 315. A flat antenna 340, preferably of the loop type, may also be disposed on the film 315. Traces of the antenna 340 may run along an outer edge of that film 315. The loops may surround the conductive patches 320. In order to electrically connect single loops in a spiral structure, connections 345 may be required which are isolated from the wires 325. Ends of the antenna 340 may be electrically connected through wires 350 to the control unit 125.

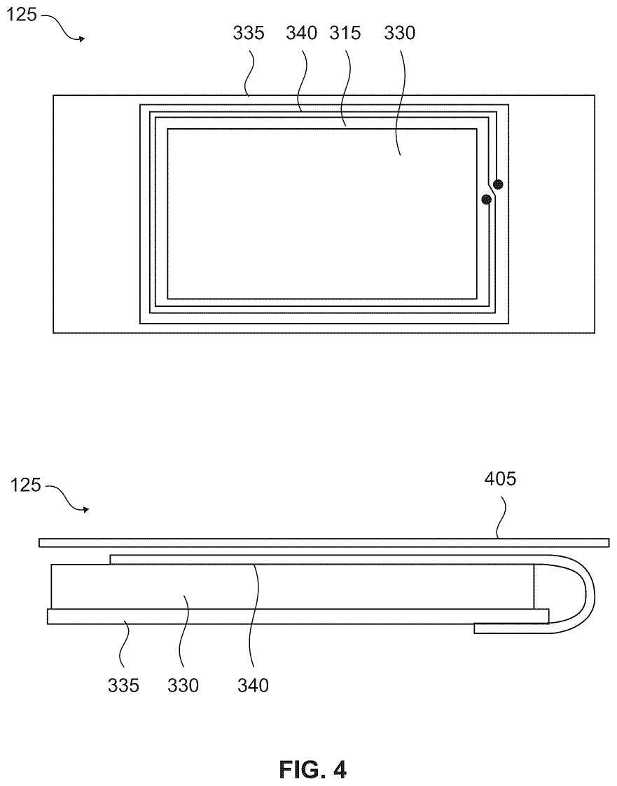

FIG. 4 shows an exemplary control unit 125 for a household appliance 105, 110. In an upper section, a top view is shown, whereas in a lower section of FIG. 4 the control unit 125 can be seen from a side perspective. The two illustrations do not necessarily pertain to the same embodiment.

It can be seen that the printed circuit board 335 acts as a carrier for other elements. On top of the printed circuit board 335, the display unit 330 may be disposed and on top of the display unit 330 the transparent film 315 may be disposed. Contacts of the antenna 340 may be connected to the printed circuit board 335 vertically. As shown in the side view, the transparent film 315 may be bent around an edge of the printed circuit board 335. Traces on the film 315 may thus be led to a lower side of the printed circuit board 335 and connected there.

Also shown in FIG. 4 is a protective layer 405 which is preferred to be disposed between the transparent film 315 and an exterior of the household appliance 105, 110. The layer 405 may help keeping dirt, grease or scratches from the film 315. The layer 405 may be made out of plastic or glass or any other suitable protective material. In embodiments where a display unit 330 is used, the layer 405 is preferred to be at least partially transparent.

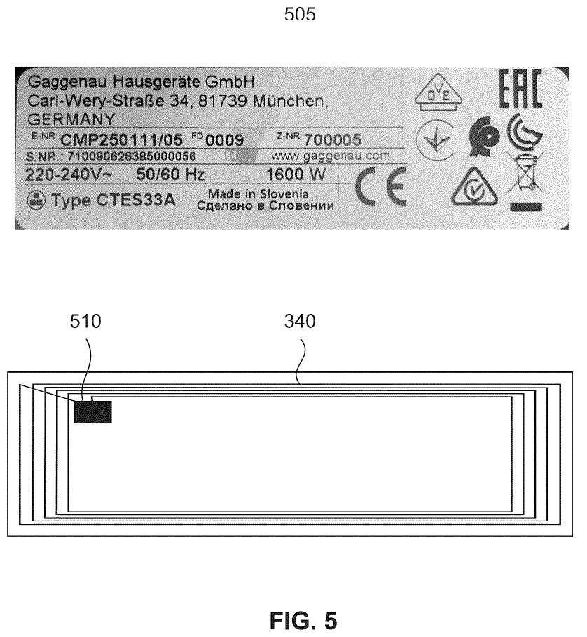

FIG. 5 shows an identification patch 505 for covering a flat antenna 340 of a control unit 125 of a household appliance 105, 110. The patch 505 carries printed information that informs about a name, weightings, specification or contact information for a household appliance 105, 110. The information is generally human readable and some of the given information may be clearly required.

The patch 505 may cover the antenna 340 of a first wireless interface 130 of a control unit 125. The antenna 340 may be mounted on top of some carrier like a film 315, a printed circuit board 335 or an outer surface of a household appliance 105, 110. In one embodiment, a semiconductor chip 510 may be disposed close to the antenna 340, the semiconductor chip 510 being adapted to provide identification, specification or rating information of the household appliance 105, 110 via a first wireless interface 130 using the antenna 340.

The following is a summary list of reference numerals and the corresponding structure used in the above description of the invention:
100 system
105 first household appliance
110 second household appliance
115 mobile device
120 external component
125 control unit
130 first wireless interface
135 second wireless interface
140 input/output unit
145 functional unit
200 first method
205 configure first household appliance
210 transfer user setting data to mobile device
215 bring mobile device to different second household appliance
250 second method
255 transfer user setting data to second household appliance
260 control function of second household appliance
305 first user interface
310 second user interface
315 film
320 conductive patch
325 wire
330 display unit
335 printed circuit board
340 antenna
345 connection
350 wire
405 protective layer
505 identification patch
510 semiconductor chip

1. A household appliance, comprising:
a controller for controlling a function of the household appliance dependent on a user setting; and
a wireless interface for communicating with a mobile device, wherein said controller is adapted to exchange user setting data with the mobile device.

2. The household appliance according to claim 1, wherein said wireless interface contains a near field communications (NFC) interface.

3. The household appliance according to claim 2, wherein said NFC interface is capable of passive operation only.

4. The household appliance according to claim 1,
wherein said wireless interface is a first wireless interface;
further comprising a second wireless interface; and
wherein said controller is adapted to establish a data link on said second wireless interface through communication on said first wireless interface.

5. The household appliance according to claim 1, wherein said controller is adapted to transfer the user setting data to the mobile device.

6. The household appliance according to claim 1, wherein said controller is adapted to accept the user setting data from the mobile device and to control the function dependent on the user setting data accepted.

7. The household appliance according to claim 1, wherein said wireless interface contains a loop antenna having conductive strips disposed on a transparent film, said transparent film being disposed at an outer surface of the household appliance.

8. The household appliance according to claim 7, wherein:
said transparent film has conductive patches; and
said controller is adapted to determine a touch on said transparent film at one of said conductive patches based on a change in capacitance of said one conductive patch.

9. The household appliance according to claim 1, wherein said controller is adapted to provide identification information of the household appliance through said wireless interface.

10. The household appliance according to claim 9, wherein said wireless interface contains a flat antenna and a patch with printed identification information of the household appliance covering said flat antenna.

11. The household appliance according to claim 1, further comprising a kitchen machine.

12. A system, comprising
a first household appliance, containing:
a first controller for controlling a function of said first household appliance dependent on a first user setting;
wireless interfaces including a first wireless interface for communicating with a mobile device, wherein said first controller is adapted to exchange first user setting data with the mobile device, and a second wireless interface; and
wherein said first controller is adapted to establish a data link on said second wireless interface through communication on said first wireless interface; and
a second household appliance, containing:
a second controller for controlling a function of said second household appliance dependent on a second user setting; and
a third wireless interface for communicating with the mobile device, wherein said second controller is adapted to exchange second user setting data with the mobile device, wherein said second controller is adapted to transfer the second user setting data to the mobile device.

13. The system according to claim 12, further comprising said mobile device being part of the system, wherein said mobile device has a smartphone.

14. A method for controlling a first household appliance, wherein the method comprises the steps of:
establishing a wireless connection between the first household appliance and a mobile device;
determining user setting data which controls a function of the first household appliance; and
transferring the user setting data to the mobile device.

15. A method for controlling a second household appliance, wherein the method comprises the steps of:
establishing a wireless connection between the second household appliance and a mobile device;
receiving user setting data from the mobile device; and
controlling a function of the second household appliance dependent on the user setting data received.
